(19) United States
(12) Patent Application Publication
(10) Pub. No.: US 2026/0333458 A1
(43) Pub. Date: Oct. 22, 2026

(54) PHYSICAL RANDOM ACCESS CHANNEL (PRACH) INDICATION OF WHETHER PREDICTION WAS USED FOR PHYSICAL DOWNLINK CONTROL CHANNEL ORDERED PRACH TRANSMISSION

(71) Applicant: QUALCOMM Incorporated, San Diego, CA (US)

(72) Inventors: Qiaoyu LI, Beijing (CN); Jelena DAMNJANOVIC, Del Mar, CA (US); Mahmoud TAHERZADEH BOROUJENI, San Diego, CA (US)

(21) Appl. No.: 19/486,311

(22) PCT Filed: Aug. 2, 2023
(86) PCT No.: PCT/CN2023/110762

§ 371 Date: Nov. 20, 2025

(51) Int. Cl. H04W 74/0833; H04W 72/23

(52) U.S. Cl. CPC H04W 74/0833; H04W 72/23

(57) ABSTRACT

Certain aspects of the present disclosure provide techniques for providing an indication to a network entity whether an apparatus has measured the first SSB or whether the apparatus has predicted a measurement of the first SSB. An aspect includes a method for wireless communications by an apparatus, the method including: receiving a physical downlink control channel (PDCCH) order triggering physical random access channel (PRACH) transmission by the apparatus; and after receiving the PDCCH order, transmitting a first PRACH preamble in a first random access channel (RACH) occasion associated with a first synchronization signal block (SSB), the first SSB associated with a transmit beam of a network entity, wherein the first PRACH preamble and the first RACH occasion identify whether the apparatus has measured the first SSB or whether the apparatus has predicted a measurement of the first SSB.

### INTRODUCTION

### Field of the Disclosure

Aspects of the present disclosure relate to wireless communications, and more particularly, to techniques for physical downlink control channel (PDCCH) ordered physical random access channel (PRACH) transmission.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

In certain aspects, a UE may be configured to measure and/or predict channel characteristics for one or more candidate cells as part of a determination of whether the UE should perform a handover from a current serving cell (also referred to as a source cell) of the UE to one of the candidate cells, the one of the candidate cells being referred to as a target cell. For example, the UE may actually measure and/or predict (e.g., using a machine learning (ML) model or other techniques) a measurement (e.g., reference signal received power (RSRP)) of each of one or more synchronization signal blocks (SSBs) of the one or more candidate cells, and, in some cases, may provide information regarding the measurements (e.g., actual and/or predicted) to a source network entity of the serving cell. In particular, a network entity of a cell may be configured to transmit one or more SSBs, and each SSB may be associated with a different downlink transmit beam of the network entity, such that the network entity may transmit the SSB using an associated downlink transmit beam. The UE may measure a given SSB transmitted by the network entity, or may predict the measurement of a given SSB, such as based on a measurement of another SSB, and in some cases, information regarding a relationship between the measured SSB and the predicted SSB, such as between characteristics (e.g., angle, strength, etc.) of a first downlink transmit beam associated with the measured SSB and characteristics of a second downlink transmit beam associated with the predicted SSB. The UE may even predict a measurement of an SSB (e.g., virtual SSB) not actually transmitted by the network entity, such as based on a relationship between the predicted SSB and an actually measured SSB. Where an SSB is actually measured by the UE, it may be referred to as a measured SSB. Where a measurement of an SSB is predicted by the UE, it may referred to as a predicted SSB.

In certain aspects, such as prior to selection of a target cell among the candidate cell(s), and such as prior to triggering of a handover from the source cell to the target cell (e.g., using lower layer triggered mobility (LTM)), the UE may receive one or more physical downlink control channel (PDCCH) orders from a network entity (e.g., source network entity of source cell, candidate network entity of candidate cell, etc.), a given PDCCH order triggering the UE to perform a random access channel (RACH) procedure with a candidate network entity of a candidate cell, such as in order to determine a timing advance (TA) for the UE to communicate with the candidate network entity of the candidate cell, should the candidate cell be selected as the target cell for a handover. The TA is used to adjust an uplink frame timing relative to a downlink frame timing when communicating in the candidate cell. Different UEs communicating in a cell may use different TAs, such as due to the different UEs having different propagation delays of signals communicated between the UEs and the network entity of the cell. The different TAs ensure that uplink signals from the UEs, when arriving at the network entity of the cell, are aligned in time with an uplink frame timing at the network entity.

As part of the RACH procedure for a candidate cell, the UE may be configured to transmit a physical random access channel (PRACH) preamble to the candidate network entity of the candidate cell. In particular, the UE may be configured to transmit the PRACH preamble in a RACH occasion (RO) associated with an SSB, of the candidate network entity, for which a measurement is predicted or measured by the UE. A RACH occasion may correspond to one or more time-frequency resources. In certain aspects, the PDCCH order includes an identifier of the SSB. For example, the network entity may identify an SSB for which the UE predicted or measured a measurement that meets a criteria (e.g., threshold, highest among SSBs associated with the candidate cell, etc.). In certain aspects, the PDCCH order identifies the candidate cell, and the UE identifies an SSB associated with the candidate cell, such as an SSB that meets the criteria.

The candidate network entity receives the PRACH preamble in the RO associated with the SSB, and therefore may be configured to send a random access response (RAR) physical downlink shared channel (PDSCH) to the UE using a downlink transmit beam associated with the SSB. For example the RAR PDSCH may be Type D
quasi-co-located with the SSB, such that a transmit beam used to transmit the SSB is quasi-co-located with a transmit beam used to transmit the RAR PDSCH. However, where the SSB was predicted, this results in a technical problem where the UE may not have been able to perform measurements of the SSB using different downlink receive beams of the UE, and therefore may only have a predicted set of downlink receive beams with which to receive the RAR PDSCH. Accordingly, the predicted SSB may help determine a downlink transmit beam of the candidate network entity for communication between the candidate network entity and the UE, but may not identify a downlink receive beam of the UE for communication between the candidate network entity and the UE.

Accordingly, certain aspects herein provide a technical solution by providing techniques for the UE to identify using a PRACH preamble transmitted to the candidate network entity in an RO associated with an SSB whether a measurement of the SSB was predicted or actually measured. In certain cases, where the SSB was predicted, the candidate network entity may send multiple instances of the RAR PDSCH to the UE, such as using the downlink transmit beam associated with the SSB for each instance, such that the UE may measure each instance using a different downlink receive beam of the UE, to determine an appropriate downlink receive beam of the UE to communicate with the candidate network entity. Accordingly, the UE may be able to properly receive and decode the RAR PDSCH to determine the TA, which it may not be able to do otherwise, therefore providing a beneficial technical effect. In particular, reliability of communications between the UE and the candidate cell may be enhanced.

One aspect provides a method for wireless communication by a user equipment (UE). The method includes receiving a physical downlink control channel (PDCCH) order triggering physical random access channel (PRACH) transmission by the apparatus; and after receiving the PDCCH order, transmitting a first PRACH preamble in a first random access channel (RACH) occasion associated with a first synchronization signal block (SSB), the first SSB associated with a transmit beam of a network entity, wherein the first PRACH preamble and the first RACH occasion identify whether the apparatus has measured the first SSB or whether the apparatus has predicted a measurement of the first SSB.

Another aspect provides a method for wireless communication by a network entity. The method includes receiving, from a user equipment, a first physical random access channel (PRACH) preamble in a first random access channel (RACH) occasion associated with a first synchronization signal block (SSB), the first SSB associated with a transmit beam of the network entity, wherein the first PRACH preamble and the first RACH occasion identify whether the user equipment has measured the first SSB or whether the user equipment has predicted a measurement of the first SSB.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 is a diagram depicting an example of beam management.

FIG. 6 is a diagram depicting examples of beam management procedures.

FIG. 7 is a diagram depicting example architecture of a functional framework for radio access network (RAN) intelligence enabled by data collection.

FIGS. 8A and 8B are diagrams depicting example communication resource prediction for beam selection by a UE.

FIG. 9 depicts an example lower-layer triggered mobility (LTM) procedure.

FIG. 10 depicts a process flow for communications in a network between a network entity and a UE for providing an indication to a network entity whether the UE has measured the first SSB or whether the UE has predicted a measurement of the first SSB.

FIG. 11 depicts another process flow for communications in a network between a network entity and a UE for providing an indication to a network entity whether the UE has measured the first SSB or whether the UE has predicted a measurement of the first SSB.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for providing an indication to a network entity whether a measurement of an SSB, associated with a RACH occasion on which a PRACH preamble is transmitted, is predicted or actually measured.

As part of the RACH procedure for a cell, the UE may be configured to transmit a PRACH preamble to the network entity of the cell. In particular, the UE may be configured to transmit the PRACH preamble in an RO associated with an SSB, of the network entity, for which a measurement is predicted or measured by the UE.

The network entity receives the PRACH preamble in the RO associated with the SSB, and therefore may be configured to send a RAR PDSCH to the UE using a downlink transmit beam associated with the SSB. However, where the SSB was predicted, this results in a technical problem where the UE may not have been able to perform measurements of the SSB using different downlink receive beams of the UE, and therefore may only have a predicted set of downlink receive beams with which to receive the RAR PDSCH. Accordingly, the predicted SSB may help determine a downlink transmit beam of the network entity for communication between the network entity and the UE, but may not identify a downlink receive beam of the UE for communication between the network entity and the UE, such as to properly receive the RAR PDSCH.

Accordingly, certain aspects herein provide a technical solution by providing techniques for the UE to identify using a PRACH preamble transmitted to the network entity in an RO associated with an SSB whether a measurement of the SSB was predicted or actually measured. In certain cases, where the SSB was predicted, the network entity may send multiple instances of the RAR PDSCH to the UE, such as using the downlink transmit beam associated with the SSB for each instance, such that the UE may measure each instance using a different downlink receive beam of the UE, to determine an appropriate downlink receive beam of the UE to communicate with the network entity. Accordingly, the UE may be able to properly receive and decode the RAR PDSCH to determine the TA, which it may not be able to do otherwise, therefore providing a beneficial technical effect. In particular, reliability of communications of the UE in the cell may be enhanced.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

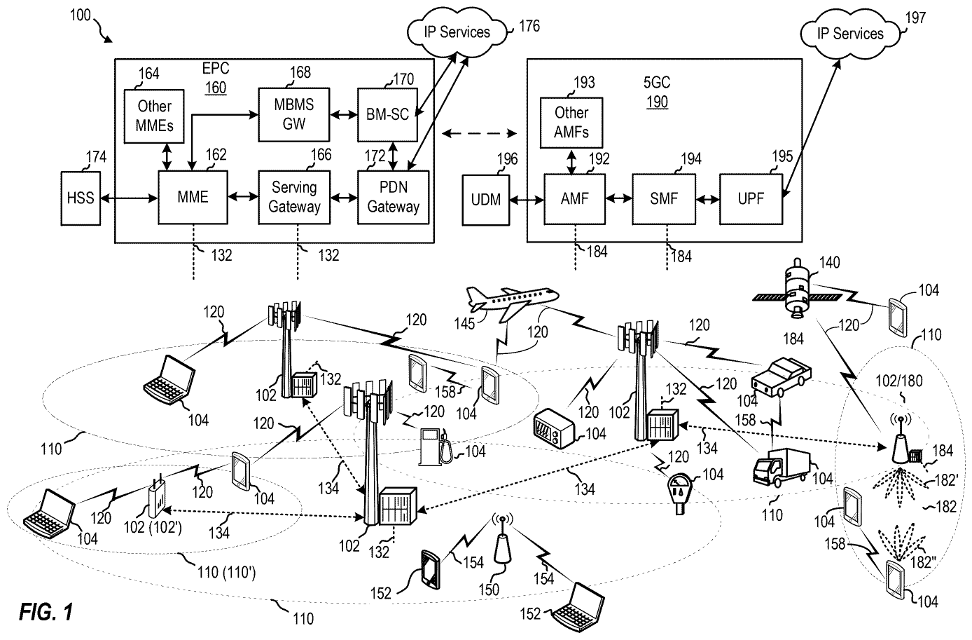

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell.

In particular, a UE being connected to, communicating with, or communicating in, a cell may refer to the UE being connected to a network entity and communicating with the network entity in a particular frequency range. A network entity may provide coverage in more than one cell, such as where the network entity communicates with UEs in different frequency ranges. Accordingly, a UE transferring from a source cell to a target cell may refer to the UE transferring from communicating with a first network entity in a first frequency range, to communicating with the first network entity in a second frequency range. As another example, a UE transferring from a source cell to a target cell may refer to the UE transferring from communicating with a first network entity in a first frequency range, to communicating with a second network entity in the first frequency range or a second frequency range.

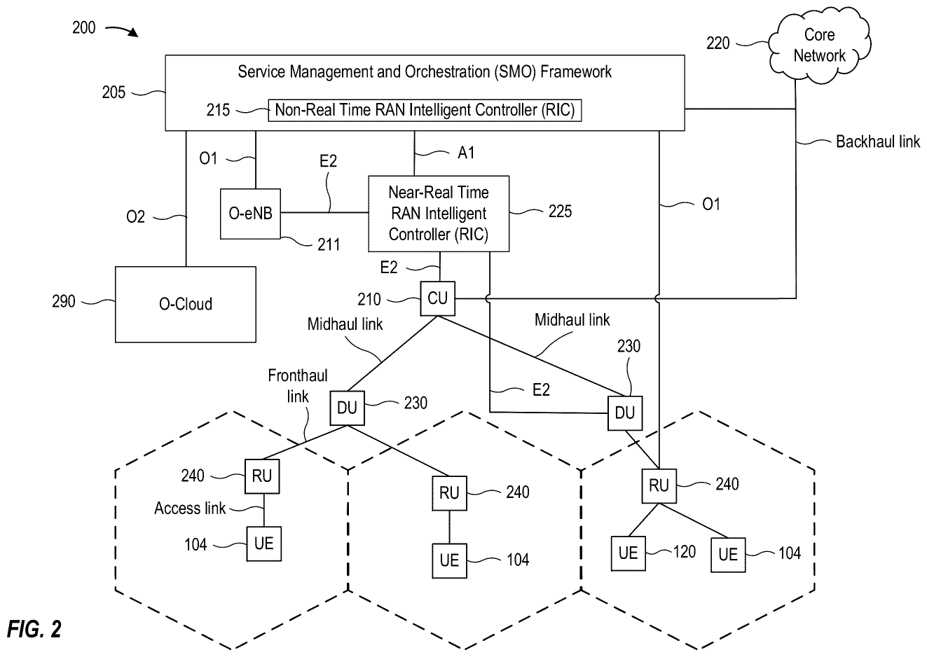

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the (e.g., best) receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

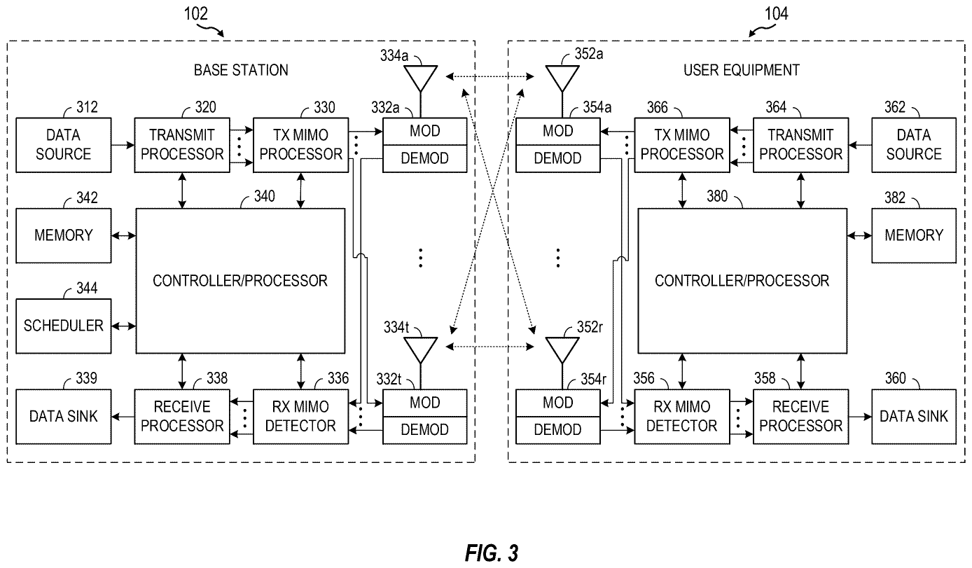

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

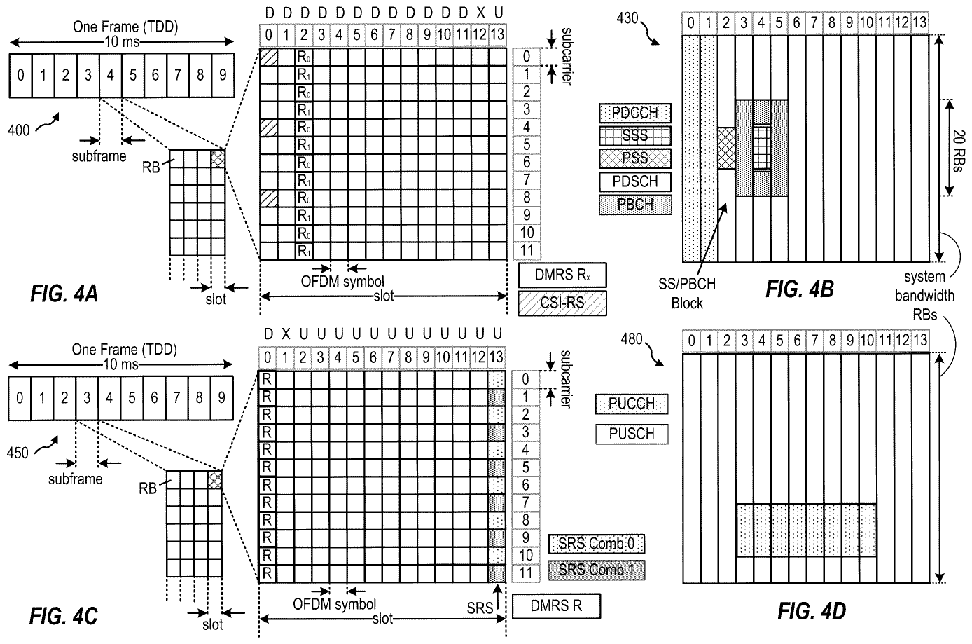

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, Uis UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Beam Management

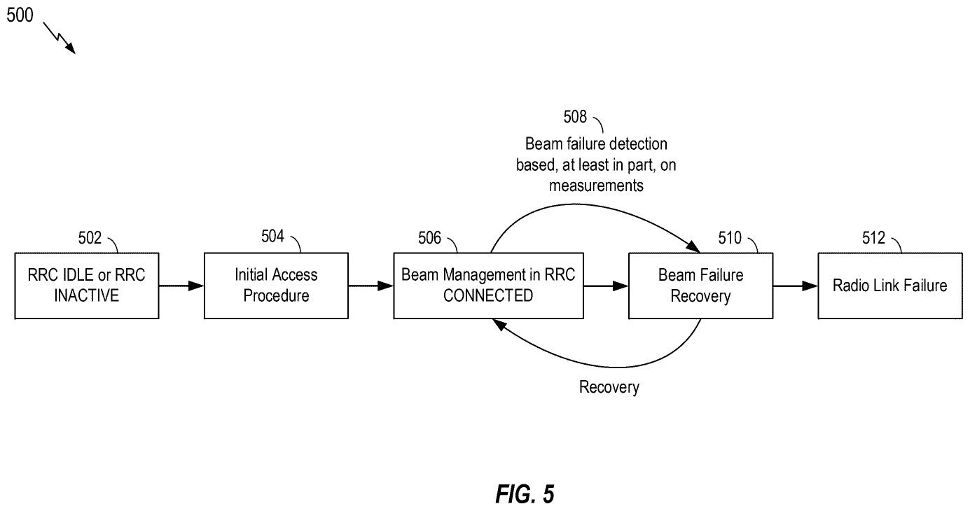

FIG. 5 is a diagram depicting example radio resource control (RRC) connection establishment and beam management 500. As shown, at 502, a user equipment (UE) may initially be in an RRC idle state (or an RRC inactivate state). An RRC idle state refers to a state of a UE where the UE is switched on but does not have any established RRC connection. The RRC idle state allows the UE to reduce battery power consumption, for example, relative to an RRC connected state. In an RRC connected state, the UE is connected to the network and radio resources are allocated to the UE.

In order to perform data transfer and/or make/receive calls, the UE needs to establish connection with a network using an initial access procedure, at 504. The initial access procedure is a sequence of processes performed between the UE and the network to establish the RRC connection. The UE may be in an RRC connected state subsequent to establishing the connection.

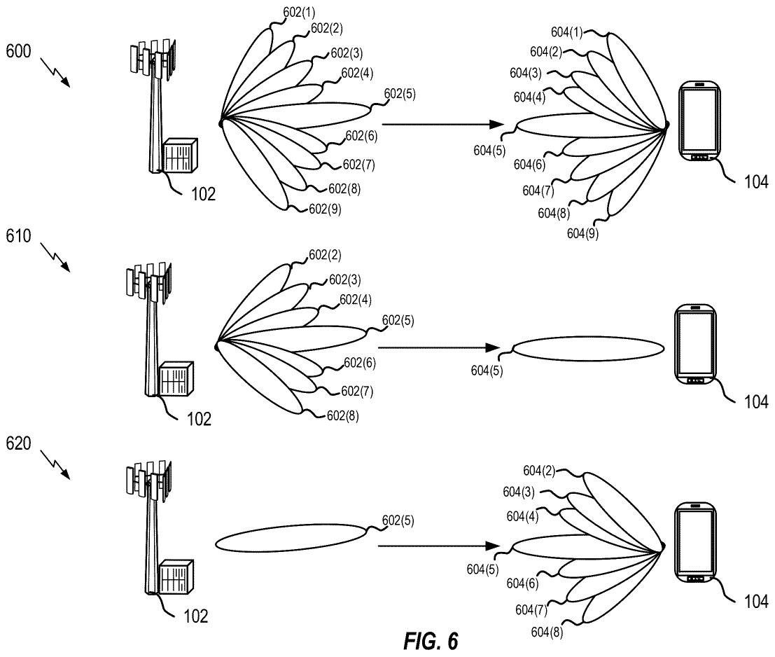

The UE may perform beam management after entering an RRC connected state. Beam management includes a set of operations used to establish and retain a (e.g., optimal) beam pair that can be used for downlink and uplink transmission/reception. A beam pair includes a transmit beam and a corresponding receive beam in one link direction. For example, for uplink communications, a beam pair may include a UE transmit beam and a network entity of a cell receive beam (corresponding to a receive beam of a network entity providing coverage in the cell). For downlink communications, a beam pair may include a UE receive beam and a network entity of a cell transmit beam (corresponding to a transmit beam of a network entity providing coverage in the cell). The beam management may include conventional P1, P2, and/or P3 beam management procedures, illustrated below in FIG. 6.

Beam management procedures may further include, at 508 and 510, beam failure detection and recovery operations. For example, a UE may detect a beam failure when layer 1 (L1) reference signal received power (RSRP) for a connected beam falls below a certain limit. After beam failure is detected, the UE identifies a candidate beam suitable for communication and performs beam failure recovery (BFR). If the BFR is not successful, the UE may declare a radio link failure (RLF), at 512.

FIG. 6 is a diagram illustrating examples 600, 610, and 620 of beam management procedures. As shown in FIG. 6, examples 600, 610, and 620 include a UE 104 in communication with a BS 102 in a wireless network (e.g., wireless communications network 100 in FIG. 1). However, the devices shown in FIG. 6 are provided as examples, and the wireless network may support communication and beam management between other devices (e.g., between a UE 104 and a network entity, a UE 104 and a transmission reception point (TRP), between a mobile termination node and a control node, between an integrated access and backhaul (IAB) child node and an IAB parent node, between a scheduled node and a scheduling node, and/or the like). In some aspects, the UE 104 and the BS 102 are in a connected state (e.g., RRC connected state and/or the like).

BS 102 and UE 104 may communicate to perform beam management using reference signals (RSS) (e.g., SSBs, demodulation reference signals (DM-RSs), channel state information reference signals (CSI-RSs), etc.).

Example 600 depicts a first beam management procedure (e.g., such as a P1 CSI-RS beam management procedure). The first beam management procedure may be referred to as a beam selection procedure, an initial beam acquisition procedure, a beam sweeping procedure, a cell search procedure, a beam search procedure, and/or the like. In example 600, reference signals are configured to be transmitted from the BS 102 to UE 104. The reference signals may be configured to be periodic (e.g., using RRC signaling), semi-persistent (e.g., using media access control (MAC) control element (MAC-CE) signaling), and/or aperiodic (e.g., using downlink control information (DCI)).

As illustrated, the first beam management procedure may include BS 102 performing beam sweeping over multiple transmit (TX) beams 602(1)-602(9) (individually referred to as “transmit beam 602” and collectively referred to as “transmit beams 602”). A transmit beam, such as transmit beam 602, is a beam, or transmission configuration indicator (TCI) state, that is used by a wireless communication device (e.g., a BS 102 and/or UE 104) for transmitting signals. For example, BS 102 may transmit a reference signal using each transmit beam 602 associated with BS 102 for beam management.

To enable UE 104 to perform receive (RX) beam sweeping (e.g., a receive beam may be a beam, a TCI state, and/or spatial relation information that is used by a wireless communication device for receiving signals), BS 102 uses a transmit beam 602 to transmit (e.g., with repetitions) each reference signal at multiple times within a same resource set to enable UE 104 to sweep through receive beams 604(1)-604(9) (individually referred to as “receive beam 604” and collectively referred to as “receive beams 604”) in multiple transmission instances. For example, if BS 102 has a set of N transmit beams 602 (e.g., in this example, N is equal to nine) and UE 104 has a set of M receive beams 604 (e.g., in this example, M is equal to nine), then the reference signal may be transmitted on each of the N transmit beams 602 M times such that UE 104 receives M instances of the reference signals per transmit beam 602. As a result, the first beam management procedure helps to enable UE 104 to measure a reference signal on different transmit beams 602, using different receive beams 604, to support the selection of BS 102 transmit beams 602/UE 104 receive beam(s) 604 beam pair(s). UE 104 may report the measurements to BS 102 to enable BS 102 to select one or more beam pair(s) for communication between BS 102 and UE 104.

Example 610, illustrated in FIG. 6, depicts a second beam management procedure (e.g., such as a P2 CSI-RS beam management procedure). The second beam management procedure may be referred to as a beam refinement procedure, a BS beam refinement procedure, a TRP beam refinement procedure, a transmit beam refinement procedure, and/or the like.

As illustrated, the second beam management procedure includes BS 102 performing beam sweeping over one or more transmit beams 602 (e.g., transmit beams 602(2)-602(8)). The one or more transmit beams 602 (e.g., transmit beams 602(2)-602(8)) may be a subset of all transmit beams 602 associated with BS 102 (e.g., determined based, at least in part, on measurements reported by UE 104 in connection with the first beam management procedure). BS 102 transmits a reference signal using each transmit beam 602(2)-602(8) for beam management. UE 104 measures each reference signal using a single (e.g., a same) receive beam 604 (e.g., determined based, at least in part, on measurements performed in connection with the first beam management procedure). For example, UE 104 measures each reference signal using receive beam 604(5). As such, the second beam management procedure may enable BS 102 to select a (e.g., best) transmit beam 602 (e.g., from transmit beams 602(2)-602(8)) based on measurements of the reference signals (e.g., measured by UE 104 using the single receive beam 604(5)) reported by UE 104. For example, the second beam management procedure may enable BS 102 to select a (e.g., best) transmit beam 602 as transmit beam 602(5).

Example 620, illustrated in FIG. 6, depicts a third beam management procedure (e.g., such as a P3 CSI-RS beam management procedure). The third beam management procedure may be referred to as a beam refinement procedure, a UE beam refinement procedure, a receive beam refinement procedure, and/or the like.

As illustrated, the third beam management procedure includes BS 102 transmitting one or more reference signals using a single transmit beam 604 (e.g., determined based, at least in part, on measurements reported by UE 104 in connection with the first beam management procedure and/or the second beam management procedure). For example, BS 102 transmits one or more reference signals using transmit beam 602(5). To enable UE 104 to perform receive beam sweeping, BS 102 may use transmit beam 602(5) to transmit (e.g., with repetitions) reference signals at multiple times within a same resource set such that UE 104 can sweep through one or more receive beams 604 (e.g., receive beams 604(2)-604(8)) in multiple transmission instances. The one or more receive beams 604 (e.g., receive beams 604(2)-604(8)) may be a subset of all receive beams 604 associated with UE 104 (e.g., determined based on measurements performed in connection with the first beam management procedure and/or the second beam management procedure). The third beam management procedure helps to enable BS 102 and/or UE 104 to select a (e.g., best) receive beam 604 (e.g., from receive beams 604(2)-604(8)) based on reported measurements received from UE 104 (e.g., of the reference signal of the transmit beam 602(5) using the one or more receive beams 604(2)-604(8)). For example, the third beam management procedure may enable UE 104 to select a (e.g., best) receive beam 604 as receive beam 604(5).

FIG. 6 is provided as an example of beam management procedures for determining a beam pair with good connectivity for communication. Other examples of beam management procedures that differ from what is described with respect to FIG. 6, however, may be considered when determining beam pairs for wireless communication.

As illustrated in FIG. 6, the conventional method of beam selection, also referred to as an exhaustive search, searches each beam, one by one, for a combination between a transmitter and a receiver that will result in a maximum value of a given criterion, such as transmitter/receiver channel gain. Although the exhaustive search method helps to select a suitable transmission/reception beam pair, this method becomes impractical due to both (1) the exponentially increasing search time as a number of beams and/or radiation patterns increases and (2) ultra-low latency requirements (e.g., requirements to process a very high volume of data packets with an extraordinarily low tolerance for delay), for example, which is forecasted to be around 1-10 us for 6G technology. As such, beam selection in beam management procedures has become a challenging task. Additionally, technical problems associated with conventional beam management procedures are further attributed to increased user mobility, increased number of antennas, and the adoption of higher frequencies in different generation wireless networks, such as 5G, 5G-Advanced, and 6G networks.

### Aspects Related to ML-Aided Beam Management Procedures

Artificial intelligence (AI), and more specifically, machine learning (ML) techniques have been introduced to help overcome the technical problems associated with conventional beam management procedures, such as those present in 5G, 5G-Advanced, and 6G networks, as described above. ML, a subdivision of AI, refers to training computer algorithms to make predictions based on experience. ML is an efficient tool that may be used to help reduce the complexity involved in generating beams and the overhead associated with beam management without sacrificing system performance. For example, with the help of ML techniques, beam selection may be performed in a fraction of the time taken by conventional exhaustive search methods and with performance comparable to that of such methods.

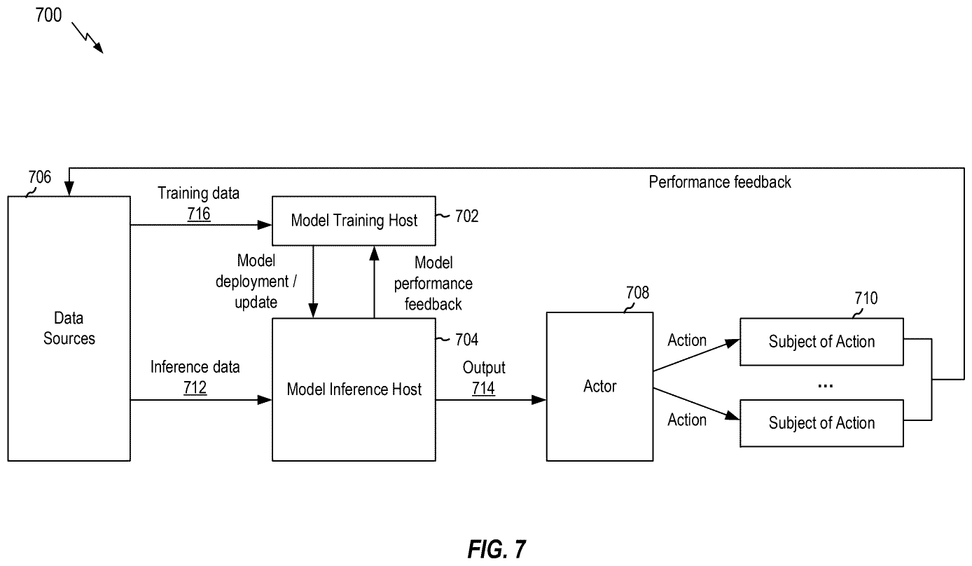

FIG. 7 is a diagram illustrating an example architecture 700 of a functional framework for radio access network (RAN) intelligence enabled by data collection. As illustrated, architecture 700 includes multiple logical entities, such as a model training host 702, a model inference host 704, data sources 706, and an actor 708. RAN intelligence enabled by ML and the associated functional framework may be utilized in various use cases, such as beam management, energy saving, load balancing, mobility management, and/or coverage optimization, among other examples. One or more benefits may be realized through the use of ML enabled RAN in such use cases.

Model inference host 704, in architecture 700, is configured to run an ML model based on inference data 712 provided by data sources 706. Model inference host 704 may produce an output 714 (e.g., a prediction) based on inference data 712, that is then provided as input into actor 708. Inference data 712 may include, for example, measurements of one or more SSBs, and in some cases, characteristics of one or more beams (e.g., downlink transmit beams, downlink receive beams, etc.) associated with the one or more SSBs. Output 714 may include, for example, one or more predicted measurements of one or more SSBs, such as one or more SSBs associated with one or more beams (e.g., downlink transmit beams, downlink receive beams, etc.).

Actor 708 may be an element or an entity of a core network (CN) or a RAN. For example, actor 708 may be a UE (e.g., UE 104 in FIG. 1), a BS (e.g., a BS 102 in FIG. 1) or another network node (e.g., a gNB, a centralized unit (CU), a distributed unit (DU), and/or a radio unit (RU)), among other examples. Additionally, the type of actor 708 may also depend on the type of tasks performed by model inference host 704, the type of inference data 712 provided to model inference host 704, and/or the type of output 714 produced by model inference host 704.

For example, if output 714 from model inference host 704 is associated with beam management (e.g., produced from ML model(s) described in more detail below with respect to FIG. 7), actor 708 may be a UE, a DU, or an RU. As another example, if output 714 from model inference host 704 is associated with transmission and/or reception scheduling, actor 708 may be a CU or a DU.

After actor 708 receives output 714 from model inference host 704, actor 708 may determine whether to act based on the output. For example, if actor 708 is a DU or an RU and the output from model inference host 704 is associated with beam management, actor 708 may determine whether to change/modify a transmission and/or a reception beam based on output 714. If actor 708 determines to act based on output 714, actor 708 may indicate the action to at least one subject of action 710. For example, if actor 708 determines to change/modify a transmission and/or reception beam for a communication between actor 708 and the subject of action 710 (e.g., a UE), then actor 708 may transmit a beam (re-) configuration or a beam switching indication to subject of action 710. Actor 708 may modify its transmission and/or reception beam based on the beam (re-) configuration, such as switching to a new transmission and/or reception beam and/or applying different parameters for a transmission and/or reception beam, among other examples. As another example, actor 708 may be a UE, and output 714 from model inference host 704 may be associated with beam management. For example, output 714 may be one or more predicted measurement values for one or more beams or communication resources (e.g., SSBs communicated in the communication resources). Actor 708, the UE, may determine that a measurement report (e.g., an L1 RSRP report) is to be transmitted to a BS in communication with the UE. In some cases, actor 708 and subject of action 710 are the same entity.

Data sources 706 may be configured for collecting data that is used as training data 716 for training an ML model, or as inference data 712 for feeding an ML model inference operation. In particular, data sources 706 may collect data from one or more CN and/or RAN entities, which may include subject of action 710, and provide the collected data to a model training host 702 for ML model training. For example, after a subject of action 710 (e.g., a UE) receives a beam configuration from actor 708, subject of action 710 may provide performance feedback associated with the beam configuration to data sources 706, where the performance feedback may be used by the model training host 702 for monitoring and/or evaluating the ML model performance, such as whether output 714, provided to actor 708, is accurate. In some examples, if output 714 provided to actor 708 is inaccurate (or the accuracy is below an accuracy threshold), then model training host 702 may determine to modify or retrain the ML model used by model inference host 704, such as via an ML model deployment/update. In some aspects, training data 716 includes measurements of one or more SSBs, and in some cases, characteristics of one or more beams (e.g., downlink transmit beams, downlink receive beams, etc.) associated with the one or more SSBs.

In some aspects, an ML model is deployed at or on a network entity (e.g., such as BS 102 in FIG. 1) for purposes of spatial domain (SD), temporal domain (TD), and/or frequency domain (FD) beam prediction. More specifically, a model interference host, such as model inference host 704 in FIG. 7, may be deployed at or on the network entity for such beam prediction. The TD refers to the analytic space in which signals are conveyed in terms of time, rather than frequency. The FD refers to the analytic space in which signals are conveyed in terms of frequency, rather than time. For example, the network entity may be configured to predict downlink receive (RX) beams that are to be used by a UE for receiving downlink transmission(s) from the network entity. To enable such prediction, the UE may be required to feed back its receive beam information (e.g., beam shapes, direction, beamforming, gains, and/or the like) to the network entity.

In some other aspects, an ML model is deployed at or on a UE (e.g., such as UE 104 in FIG. 1) for purposes of SD, TD, and/or FD beam prediction. More specifically, a model inference host, such as model inference host 704 in FIG. 7, may be deployed at or on the UE for such beam prediction. A scenario where the ML model, at or on the UE, is configured to predict SD beams may be referred to as a beam management case 1, or simply “BM-Case1.” Additionally, a scenario where the ML model, at or on the UE, is configured to predict TD beams may be referred to as a beam management case 2, or simply “BM-Case2.”

SD communication resource (e.g., SSB) prediction may refer to predicting a measurement for a first communication resource associated with a first beam (e.g., a first transmit beam of a network entity) based on a measurement of a second communication resource associated with a second beam (e.g., a second transmit beam of the network entity), wherein the first communication resource and the second communication resource correspond to a same time and frequency resource. FD communication resource prediction may refer to predicting a measurement for a first communication resource associated with a first beam (e.g., a first transmit beam of a network entity) based on a measurement of a second communication resource associated with the first beam, wherein the first communication resource and the second communication resource correspond to a same time resource but a different frequency resource. TD communication resource prediction may refer to predicting a measurement for a first communication resource associated with a first beam (e.g., a first transmit beam of a network entity) based on a measurement of a second communication resource associated with the first beam, wherein the first communication resource and the second communication resource correspond to a same frequency resource but a different time resource.

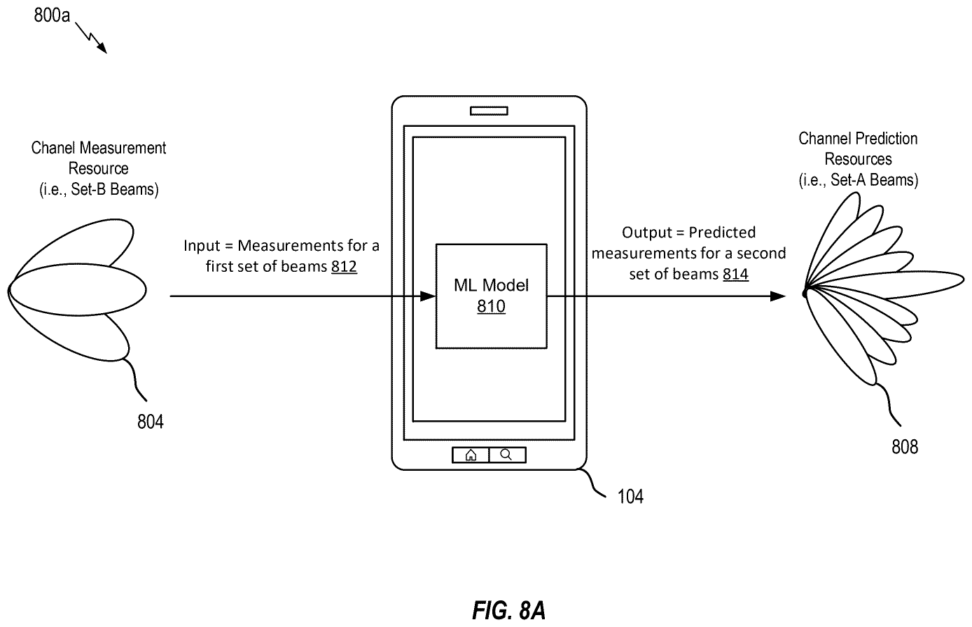

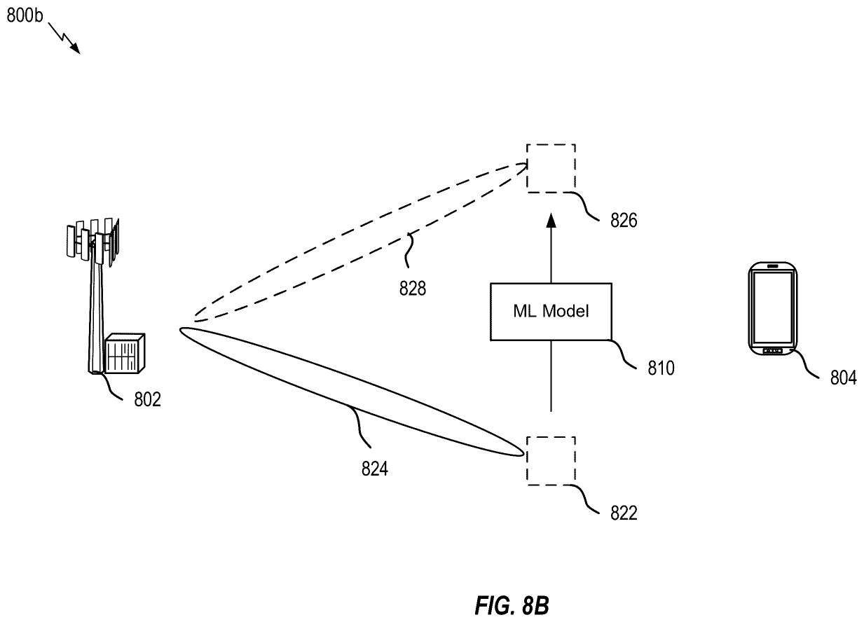

FIG. 8A is a diagram illustrating example beam prediction 800a by a UE 104. In FIG. 8A, an ML model 810 is deployed at or on UE 104 to enable UE 104 to make one or more beam predictions based on data input to ML model 810.

For example, a BS 102 may transmit one or more signals, such as one or more SSBs, via a first set of beams 804, in a first set of communication resources. UE 104 may perform measurements (e.g., L1 RSRP measurements and/or other measurements) of the one or more signals transmitted in the first set of communication resources, or a subset thereof, to obtain a first set of measurements 812 (sometimes referred to as parameters or channel characteristics). For example, each beam (or else a subset thereof) 804, from the first set of beams carrying the one or more signals, may be associated with one or more measurements 812 performed by UE 104. UE 104 may input the first set of measurements 812 (e.g., L1 RSRP measurement values) into ML model 810 along with information associated with the first set of beams and/or first set of communication resources (or a subset thereof). The information associated with the first set of beams may include a beam direction (e.g., a spatial direction), beam width, beam shape, and/or other characteristics of the respective beam.

ML model 810 may be configured to output one or more predictions. More specifically, ML model 810 may be configured to predict one or more measurement values 814 for a second set of communication resources 806 associated with a second set of beams 808, such as measurement values for one or more SSBs that could have been communicated in the second set of communication resources 806. The one or more measurement values 814 may include predicted channel characteristics (e.g., predicted L1 RSRP measurement values) associated with the second set of communication resources 806, where the second set of communication resources 806 are associated with the second set of beams 808.

In some examples, the first set of beams 804 (e.g., that are measured) may be referred to as “Set B beams” and the second set of beams 808 (e.g., that are associated with predicted measurements for the second set of communication resources 806) may be referred to as “Set A beams.” Put another way, the “Set B beams” are a set of beams for which measurements are taken and used as inputs in ML model 810, while the “Set A beams” are a set of beams for which ML model 810 performs predictions.

In some examples, first set of beams 804 are a subset of second set of beams 808. In some other examples, first set of beams 804 and second set of beams 808 are different beams and/or may be mutually exclusive sets. For example, first set of beams 804 may include wide beams (e.g., unrefined beams or beams having a beam width that satisfies a first threshold), and second set of beams 808 may include narrow beams (e.g., refined beams or beams having a beam width that satisfies a second threshold).

Use of ML model 810 for beam prediction may reduce a quantity of beam measurements that are performed by UE 104 (e.g., compared to exhaustive search methods described above with respect to FIG. 6), thereby conserving power at UE 104 and/or network resources that would have otherwise been used to measure all beams included in at least the first set of beams.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of ML model 810 may include a point-direction, an angle of departure (AoD), and/or an angle of arrival (AoA) of a beam included in the second set of beams (e.g., the “Set A beams”). This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to ML model 810. This may enable ML model 810 to output codebook-based and/or non-codebook-based predictions for a measurement value, an AoD, and/or an AoA, among other examples, of a beam at a future time. The output(s) of ML model 810, may facilitate initial access procedures, secondary cell group (SCG) setup procedures, beam refinement procedures (e.g., a P2 beam management procedure and/or a P3 beam management procedure as described above with respect to FIG. 6), link quality or interference adaptation procedures, beam failure and/or beam blockage predictions, and/or radio link failure predictions, among other examples.

In some aspects, an output of ML model 810 may include a temporal beam prediction. The TD beam prediction may be associated with a serving beam refinement, a link quality (e.g., CQI or PMI) and interference adaptation, a beam failure/blockage prediction, and/or a radio link failure (RLF) prediction. For example, the ML model 810 may predict channel characteristics for a given beam and a given frequency for a future time based on a measurement of a signal communicated on the given beam and the given frequency.

In some aspects, ML model 810 performs SD downlink beam predictions for beams included in the “Set A beams” based on measurement results of beams included in the “Set B beams.” In some aspects, ML model 810 performs TD downlink beam prediction for beams included in the “Set A beams” based on historic measurement results of beams included in the “Set B beams.”

### Aspects Related to the Prediction of Communication Resources

In some aspects, an ML model is deployed for predicting communication resources, such as to assist in determining a set of beams (e.g., uplink receive beams, uplink transmit beams, downlink receive beams, and/or downlink transmit beams) to be used for communication. In certain aspects, predicting communication resources to assist in determining a set of beams to be used for communication may be referred to as predicting beams. In certain aspects, predicting communication resources corresponds to predicting measurement(s) of SSB(s), and in some cases, beam(s) associated with the SSB(s). A “set” as discussed herein may include one or more elements. Accordingly, a set of beams includes one or more beams. For example, FIG. 8B is a diagram illustrating example communication resource prediction 800b by a UE 104 based on measurement of a signal (e.g., SSB) from a network entity 802, such as BS 102 of FIG. 1. In FIG. 8B, an ML model 810 is deployed at or on UE 104 to enable UE 104 to make one or more communication resource predictions based on data input to ML model 810. Though embodiments herein describe the use of an ML model to predict communication resources associated with a set of beams, in certain other embodiments, other prediction techniques (e.g., defined in a specification, such as 3GPP) may be used to predict the communication resources. Further, the prediction may occur somewhere else than UE 104, such as where UE 104 sends measurement information to another device to perform prediction, where the ML model is deployed at the other device.

To perform communication resource prediction, network entity 802 may first transmit one or more signals, such as SSBs, via a first set of beams 824, in a first set of communication resources 822. Network entity 802 may be any network entity, such as BS 102 in FIGS. 1 and 3. The first set of beams 824 may be a first set of downlink transmit beams of the network entity 802. UE 104 may measure the one or more signals transmitted in the first set of communication resources 822, to obtain a first set of measurements (sometimes referred to as parameters or channel characteristics), such as RSRPs.

For example, each signal carried via each beam in the first set of beams 824 may be associated with one or more measurements performed by UE 104. UE 104 may input the first set of measurements into ML model 810. In some aspects, information associated with the first set of beams 824 (e.g., beam direction, beam width, beam shape, and/or other characteristics) is also input into ML model 810 for communication resource prediction.

ML model 810 is configured to output one or more predictions, and more specifically, is configured to predict communication resources, such as measurements of one or more SSBs that may be communicated on one or more communication resources. As used herein, predicting communication resources comprises predicting one or more parameters associated with the communication resources, such as measurements of one or more SSBs that may be communication on the communication resources. For example, based on the one or more measurements provided as input into ML model 810, ML model 810 predicts one or more parameters (e.g., measurement values and/or channel characteristics, such as one or more measurements of one or more SSBs) for a second set of communication resources 826 (e.g., associated with one or more SSBs) associated with a second set of beams 828. In certain aspects, the second set of beams 828 corresponds to a second set of downlink transmit beams of the network entity 802. For example, the ML model 810 predicts what measurement(s) of one or more signals (e.g., SSBs) would be if they were transmitted by network entity 802 on the second set of communication resources 826 using the second set of beams 828. In certain aspects, the second set of beams 828 corresponds to a set of uplink receive beams of the network entity 802. For example, the ML model 810 predicts measurement(s) of one or more signals if they had been transmitted by network entity 802 on transmit beams that have the same spatial configuration as the set of uplink receive beams.

In some aspects, UE 104 sends one or more identifiers associated with the second set of communication resources 826 to network entity 802, such as one or more identifiers of one or more SSBs. Network entity 802 may determine a set of uplink receive beams to use for receiving subsequent uplink transmission(s) from UE 104 based on the second set of communication resources 826. For example, network entity 802 may store or have access to information, such as a mapping, that associates/maps the second set of communication resources 826 with the set of uplink receive beams. In certain aspects, UE 104 may not have information regarding the association of the set of uplink receive beams with the second set of communication resources 826.

Using ML models for predicting communication resources, to assist in determining a set of beams that may be used for subsequent communication, helps to overcome technical problems associated with conventional beam selection procedures, such as those described above with respect to FIG. 6.

### Aspects Related to Lower-Layer Triggered Mobility (LTM)

Handover is a process of transferring an ongoing communication session of a UE (e.g., such as UE 104 in FIGS. 1-3) from a source cell to a target cell while in a connected state. The target cell may belong to either a same network entity as the source cell (e.g., intra-network entity (e.g., intra-gNB) handover) or a different network entity than the network entity associated with the source cell (e.g., inter-network entity (e.g., inter-gNB) handover). One of the motivations behind handover procedures is to assist in the seamless connectivity and continuity of service for the UE, especially while the UE is mobile.

New Radio (NR) supports different types of handover, including handover procedures where the network controls UE mobility based on UE measurement reporting. In this procedure, a source network entity (e.g., gNB) associated with a source cell of a UE, triggers a handover for the UE by transmitting a handover request to a target network entity associated with a target cell (e.g., inter-gNB handover). After receiving an acknowledgement (ACK) from the target gNB, the source gNB initiates the handover of the UE from the source cell to the target cell (e.g., from the source network entity to the target network entity) by transmitting a handover command with target cell configuration. The UE then accesses the target cell after the target cell configuration is applied.

Handover procedures supported in 3GPP, through Release 17, involve a serving cell change triggered by layer 3 (L3) measurements and carried out via radio resource control (RRC) signaling. Each procedure requires the reconfiguration of upper layers of the protocol stack (e.g., the RRC layer and/or the packet data convergence protocol (PDCP) layer) and/or the resetting of lower layers of the protocol stack (e.g., the medium access control (MAC) layer and/or the physical (PHY) layer), which results in increased latency, large overhead and longer interruption times.

Accordingly to overcome such problems with existing handover procedures, in 3GPP Release 18, a new layer 1 (L1)/layer 2 (L2)-based handover procedure, also referred to as “Lower Layer Triggered Mobility (LTM),” was introduced. LTM enables a handover via L1/L2 signaling. As such, any re-configuration of the upper layers may be avoided, while also minimizing changes to the configuration of the lower years of the protocol stack. The LTM supports both intra-distributed unit (DU) mobility and intra-central unit (CU)-inter-DU mobility (e.g., where the source DU and target DU are connected to a common CU).

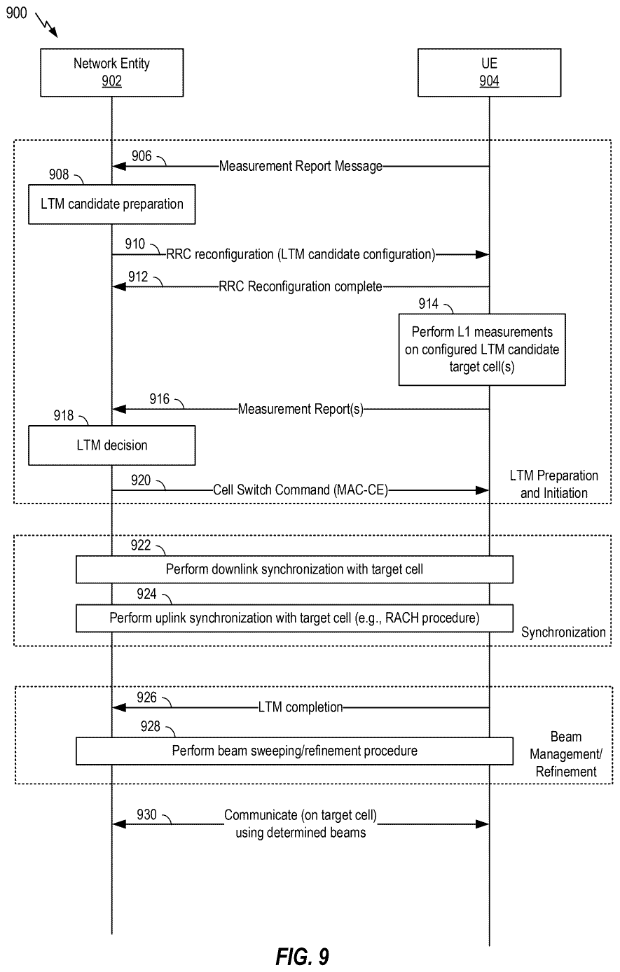

FIG. 9 depicts the procedure 900 for LTM. As illustrated, procedure 900 includes steps 906-930 broken into three categories: (1) LTM preparation and initiation, (2) synchronization, and (3) beam management/refinement. Procedure 900 begins, at step 906, by a UE 904 (e.g., such as UE 104 in FIGS. 1-3) transmitting a measurement report message to a network entity 902 (e.g., such as BS 102 in FIGS. 1 and 3). In response to receiving the measurement report message at 906, network entity 902 determines to use LTM and accordingly intiate LTM candidate prepartion, at 908, by compiling a list of one or more LTM candidate target cells for UE 904.

Procedure 900 then proceeds, at step 910, with network entity 902 transmitting an RRCReconfiguration message to UE 904, including configuration information for each of the LTM candidate target cell(s). UE 904 stores the configuration information received from network entity 902, and at step 912, an RRCReconfigurationComplete message to network entity 902.

Procedure 900 proceeds, at step 914, with UE 904 performing (e.g., L1) measurements on one or more of the configured LTM candidate cell(s). UE 904 may transmit lower-layer report(s), including information about these measurements, to network entity 902, at step 916.

At step 918, network entity 902 decides to execute an LTM cell switch to one of the LTM candidate cell(s) based on the measurement report(s) received from UE 904. Accordingly, at step 920, network entity 902 transmits, to UE 904, a MAC-CE triggering an LTM cell switch for UE 904 (also referred to herein as “a cell switch command”) to the target LTM candidate cell.

In response to receiving the cell switch command, UE 904 begins the process to synchronize with the target LTM candidate cell. In particular, at 922 and 924, respectively, UE 904 performs downlink synchronization and uplink synchronization with the target LTM candidate cell. In some cases, performing uplink synchronization includes UE 904 performing a random access channel procedure (RACH) with the target LTM candidate cell. After successful synchronization with the target LTM candidate cell, UE 904 may be switched to the configuration of the target LTM candidate cell.

Procedure 900 then proceeds, at step 926, with UE 904 transmitting an LTM completion message to network entity 902. The LTM completion message indicates successful completion of the LTM cell switch to the target LTM candidate cell.

At step 928, the target LTM candidate cell (e.g., belonging to network entity 902) and UE 904 perform beam management procedures (e.g., including beam selection and beam refinement procedures described above in FIG. 6) to determine a beam pair with good connectivity to use for communication between the target LTM candidate cell and UE 904. After step 928, procedure 900 is complete and the target LTM candidate cell and UE 904 communicate using the beams of the beam pair determined at step 930.

### Aspects Related to Providing an Indication to a Network Entity of Whether an Apparatus has Measured or Predicted an SSB

Aspects described herein provide improved functionality to random access procedure through inclusion of an indication to a network entity whether an apparatus (e.g., UE) has actually measured an SSB associated with a RACH occasion (RO) on which a PRACH preamble is transmitted, or has predicted a measurement of the SSB. In certain aspects, the random access procedure considered herein may be a “contention free” random access. In certain aspects, the network (e.g., network entity of a serving cell of the UE) shares configuration information, such as an indication of time-frequency resource(s) (e.g., corresponding to ROs) and/or preamble(s) (e.g., corresponding to PRACH preambles) that the UE may use to send a RACH request to a network entity of a cell (e.g., a source cell, candidate cell, or target cell) of the network. The random access procedure may be utilized for instances of handover (e.g., a UE switching from communication on a source cell to communication on a target cell). However, aspects of the present disclosure may also apply to an instance of a single-cell where the user equipment is establishing or re-establishing communication with the cell.

In certain aspects, the UE may receive one or more PDCCH orders from a network entity, such as of a serving cell of the UE, a given PDCCH order triggering the UE to perform a RACH procedure. In certain aspects, the PDCCH order triggers a RACH procedure with a candidate network entity of a candidate cell, such as for LTM. In certain aspects, the PDCCH order triggers a RACH procedure with a network entity of a current serving cell of the UE, such as for single-cell procedures.

As part of the RACH procedure for a cell, the UE may be configured to transmit a PRACH preamble to the network entity of the cell as part of a RACH request. In particular, the UE may be configured to transmit the PRACH preamble in an RO associated with an SSB, of the network entity.

The network entity receives the PRACH preamble in the RO associated with the SSB, and therefore may be configured to send a RAR PDSCH to the UE using a downlink transmit beam associated with the SSB. For example, the RAR PDSCH may be TypeD-quasi-co-located with the SSB. As discussed, the UE may not have been able to perform measurements of the SSB using different downlink receive beams of the UE, such as where the SSB was predicted by the UE prior. Accordingly, certain aspects herein provide techniques for the UE to identify using a PRACH preamble transmitted to the network entity in an RO associated with an SSB whether a measurement of the SSB was predicted or actually measured. In certain cases, where the SSB was predicted, the network entity may send multiple instances of the RAR PDSCH to the UE, such as using the downlink transmit beam associated with the SSB for each instance, such that the UE may measure each instance using a different downlink receive beam of the UE, to determine an appropriate downlink receive beam of the UE to communicate with the network entity. Accordingly, the PRACH preamble transmitted to the network entity in an RO associated with an SSB may indicate to the cell to transmit multiple instances of the RAR PDSCH, which may be referred to transmitting repetitions of the RAR PDSCH, where each instance of the RAR PDSCH is referred to as a repetition of the RAR PDSCH.

In certain aspects, an SSB may be associated with multiple ROs, such that a UE transmitting a PRACH preamble in any one of the multiple ROs to a network entity, indicates the SSB to the network entity. Further, the UE may be configured with multiple PRACH preambles, where the UE can transmit any one of the multiple PRACH preambles in an RO. In certain aspects, a combination of a PRACH preamble and an RO maybe referred to as a RACH resource. For example, should the UE transmit a first PRACH preamble in a first RO associated with the SSB, the UE may transmit in a first RACH resource. Should the UE transmit a first PRACH preamble in a second RO associated with the SSB, the UE may transmit in a second RACH resource. Should the UE transmit a second PRACH preamble in the first RO associated with the SSB, the UE may transmit in a third RACH resource. Should the UE transmit the second PRACH preamble in the second RO associated with the SSB, the UE may transmit in a fourth RACH resource.

In certain aspects, a given RACH resource (i.e., a given PRACH preamble and a given RO) identifies at least one of a requested number of times for a network entity to transmit a RAR PDSCH or a requested modulation and coding scheme (MCS) for the network entity to use to transmit the RAR PDSCH. Accordingly, the UE transmitting in a given RACH resource indicates to the network entity at least one of a requested number of times for a network entity to transmit a RAR PDSCH or a requested MCS for the network entity to use to transmit the RAR PDSCH. In certain aspects, where the RACH resource is associated with a request for the network entity to transmit RAR PDSCH once (i.e., without repetition) the RACH resource indicates the SSB associated with the RACH resource was actually measured by the UE. In certain aspects, where the RACH resource is associated with a request for the network entity to transmit RAR PDSCH a plurality of times the RACH resource indicates a measurement of the SSB associated with the RACH resource was predicted by the UE.

In certain aspects, the association (e.g., mapping) between RACH resources and at least one of a requested number of times for a network entity to transmit a RAR PDSCH or a requested MCS for the network entity to use to transmit the RAR PDSCH is configured at the UE and network entity (e.g., preconfigured at time of manufacture such as based on definitions in a standard, such as the 3GPP standard). In certain aspects, different cells and/or different SSBs may be associated with different associations.

In an example, the RACH resources are ordered first according to PRACH preamble identifier (e.g., preamble-ID) and second according to RACH occasion index (e.g., RO #or RO-ID). The ordered RACH resources are associated in order with at least one of different requested numbers of times to transmit the RAR PDSCH or different requested modulation and coding schemes. Table 1 below shows an example of such ordering, wherein the number of repetitions increases per the RACH resource ordering.

TABLE 1

| | RO#1 | RO#2 | RO#3 | RO#4 |
|---|---|---|---|---|
| Preamble#1 | Meas'd | Predict'd | Predict'd | Predict'd |
| | (no Rep) | Rep#4 | Rep#8 | Rep#12 |
| Preamble#2 | Predict'd | Predict'd | Predict'd | Predict'd |
| | Rep#2 | Rep#6 | Rep#10 | Rep#14 |

In other aspects, the RACH resources are ordered first according to RACH occasion index and second according to PRACH preamble identifier. The ordered RACH resources are associated in order with at least one of different requested numbers of times to transmit the RAR PDSCH or different requested modulation and coding schemes. Table 2 below shows an example of such ordering, wherein the number of repetitions increases per the RACH resource ordering.

TABLE 2

| | RO#1 | RO#2 | RO#3 | RO#4 |
|---|---|---|---|---|
| Preamble#1 | Meas'd | Predict'd | Predict'd | Predict'd |
| | (no Rep) | Rep#2 | Rep#4 | Rep#6 |
| Preamble#2 | Predict'd | Predict'd | Predict'd | Predict'd |
| | Rep#8 | Rep#10 | Rep#12 | Rep#14 |

While the Table 1 and Table 2 each only provides two preconfigured preambles and four RACH occasions, it is understood that each may have additional preconfigured options.

In certain aspects, multiple different associations (e.g., such as the two different associations corresponding to Table 1 and Table 2) between RACH resources and at least one of a requested number of times for a network entity to transmit a RAR PDSCH or a requested MCS for the network entity to use to transmit the RAR PDSCH are configured at the UE and network entity (e.g., preconfigured at time of manufacture such as based on definitions in a standard, such as the 3GPP standard). Each different association may be referred to as a configuration.

In certain such aspects, the network entity may be configured to select one of the multiple different associations and send to the UE an indication identifying one of the multiple different associations to be used by the network entity and the UE. For example, the network entity may send the indication identifying one of the multiple different associations to the UE using RRC signaling, such as part of an RRC configuration. In certain aspects, different cells and/or different SSBs may be associated with different associations. For example, the network entity may send one or more indications identifying different associations for different cells and/or different SSBs.

In certain aspects, the UE may be configured to select one of the multiple different associations and send to the network entity an indication identifying one of the multiple different associations to be used by the network entity and the UE. In certain aspects, the network entity does not send a response to the UE, and the UE and the network entity use the association selected by the UE. In certain aspects, the network entity sends a response to the UE, confirming the UE selection (e.g., identifying the association selected by the UE, or indicating a different associated to be used by the network entity and the UE.

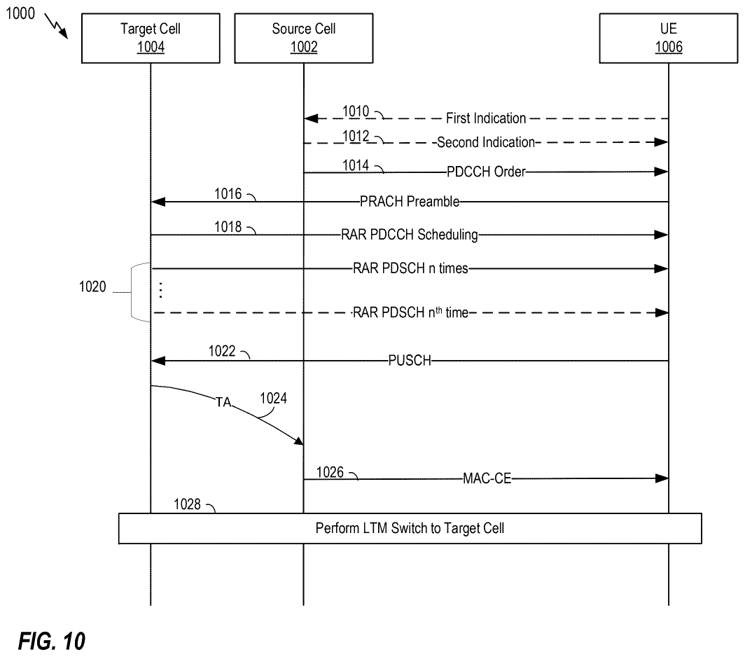

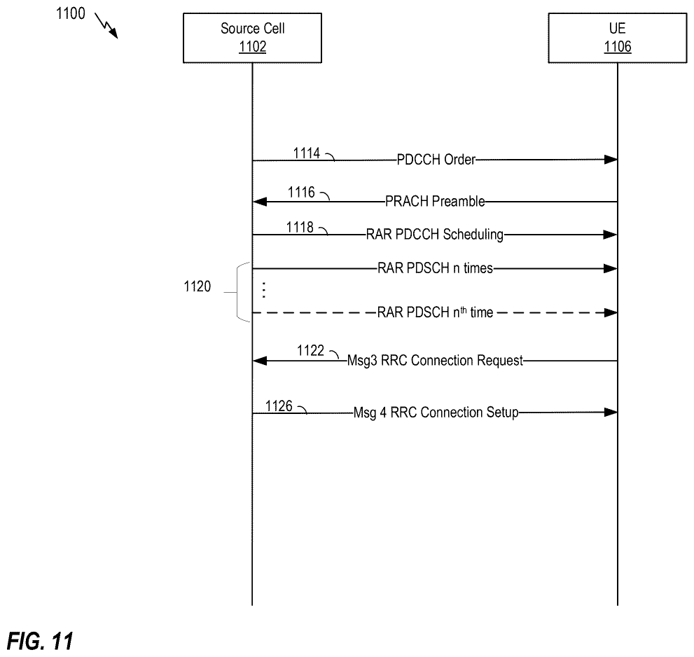

Examples of signaling designs are provided in FIGS. 10 and 11. Each of FIGS. 10 and 11 depicts a process flow 1000, 1100, respectively, for communications in a network between a source cell 1002, 1102 (e.g., a first network entity in a cell such as a BS 102, for example, as depicted and described with reference to FIGS. 1, 3, and 6), optionally a target cell 1004 (e.g., a second network entity in a cell, such as a BS 102) and a UE 1006, 1106 (e.g., any UE 104 depicted and described with reference to FIGS. 1, 3, and 6). As such communications shown as being received by or sent by a cell, may refer to communications received or sent by a network entity (e.g., DU, BS, etc.) of the cell. Further, beams of a cell may refer to beams of a network entity of the cell.

Referring to FIG. 10, optionally, the UE 1006, at step 1010 may send, to source cell 1002, a first indication identifying one of a plurality of configurations mapping RACH resources to requested numbers of times to transmit RAR PDSCH or MCSs. Optionally, at step 1012 (in combination with optional step 1010, or without step 1010), the source cell 1002 may provide the UE 1006 with an indication identifying one of the plurality of configurations (e.g., the same as identified by the UE or different).

At step 1014, the source cell 1002 transmits, to the UE 1006, a PDCCH order triggering PRACH transmission by the UE 1006. In certain aspects, the PDCCH order triggers contention-free PRACH preamble transmission associated with a first SSB. In certain aspects, the PDDCH order may include an identifier of the first SSB.

In certain aspects, the PDCCH order indicates a plurality of RACH occasions and a plurality of PRACH preambles, each combination of a RACH occasion of the plurality of RACH occasions and a PRACH preamble of the plurality of PRACH preambles identifying at least one of a different requested number of times to transmit the RAR PDSCH or a different requested MCS, wherein the plurality of RACH occasions are all associated with the first SSB.

For example, the PDCCH order may identify one of a plurality of configurations mapping RACH resources to requested numbers of times to transmit RAR PDSCH or MCSs as associated with the first SSB.

In an example, the PDCCH order may identify multiple RACH occasions associated with the first SSB during a single SSB-to-RO mapping cycle, or multiple RACH occasions associated with the first SSB across multiple SSB-to-RO mapping cycles, such as using a PRACH mask index indicated in the PDDCH order DCI. An SSB-to-RO mapping cycle may refer to a plurality of ROs recurring periodically in time. Accordingly, multiple ROs may be associated with an SSB in a given SSB-to-RO mapping cycle, and an SSB may be associated with multiple SSB-to-RO mapping cycles.

In certain aspects, the PDCCH order may identify multiple PRACH preambles, such as using preamble IDs indicated in the PDDCH order DCI.

The UE 1006 receives the PDCCH order and in response, at step 1016, transmits a PRACH preamble in a RACH occasion associated with the first SSB to target cell 1004. The PRACH preamble and the RACH occasion identify whether the UE 1006 has measured the first SSB or whether the UE 1006 has predicted a measurement of the first SSB. In some aspects, the PRACH preamble and the RACH occasion identify at least one of a requested number of times to transmit a RAR PDSCH in response to the PRACH preamble or a requested MCS.

At step 1018, in response to the PRACH preamble, the target cell 1004 transmits a RAR PDCCH. The RAR PDCCH schedules one or more transmissions of the RAR PDSCH.

In some aspects, the RAR PDCCH indicates to the UE 1006 a number of repetitions of the RAR PDSCH and/or MCS, such as where the network entity of the target cell 1004 determines the number of repetitions, such as corresponding to or different than the requested number of transmissions by the UE 1006. For example, the RAR PDCCH may indicate a transmission time of each of the one or more transmissions (e.g., a plurality of transmissions) of the RAR PDSCH.

In some aspects, the RAR PDCCH indicates a transmission time of only a first transmission in time of the RAR PDSCH, such as when the UE 1006 and network entity of the target cell 1004 assume that the number of transmissions of RAR PDSCH is equal to the requested number of transmissions by the UE 1006. The remaining RAR PDSCHs may be configured to be communicated at a configured (e.g., predefined) time with respect to the first transmission in time of the RAR PDSCH.

At step 1020, the target cell 1004 transmits and the UE 1006 receives one or more transmissions of the RAR PDSCH. In certain aspects, the RAR PDSCH is at least Type D quasi co-located with the first SSB.

At step 1022, following receipt of the one or more transmissions of the RAR PDSCH, the UE 1006 may transmit PUSCH to the target cell 1004. The target cell 1004 determines the timing advance for adjusting the uplink frame timing relative to the downlink frame timing when communicating with the UE 1006. The target cell 1004, for example, over the backhaul link, transmits the timing advance (TA) at step 1024 to the source cell 1002. At step 1026, the source cell 1002 transmits to UE 1006 MAC-CE triggering an LTM cell switch for UE 1006 to the target LTM candidate cell (e.g., the target cell 1004).

At step 1028, the UE 1006 switches to the target cell 1004 indicated by the MAC-CE. From here, additional beam selection and refinement may occur as well as communication on the target cell may commence.

Referring to FIG. 11, the process flow 1100 provides an example implementation of the aforementioned steps of providing an indication to a network entity whether an apparatus has measured the first SSB or whether the apparatus has predicted a measurement of the first SSB depicted and described with reference to the process flow 1000 of FIG. 10, but now being implemented in an instance of a single-cell.

Steps 1114, 1116, 1118, 1120, 1122, and 1126 in process flow 1100 are similar (e.g., identical) to steps 1014, 1016, 1018, 1020, 1022, and 1026 in process flow 1000 of FIG. 10. However, unlike process flow 1000, in process flow 1100, the UE 1106 is establishing connection with source cell 1102 as opposed to switching from the source cell 1102 to a target cell 1104. The triggering event, at step 1116, for the UE 1106 to transmit the PRACH preamble may be a PDCCH order from one or more network entities including the source cell 1102.

### Example Operations

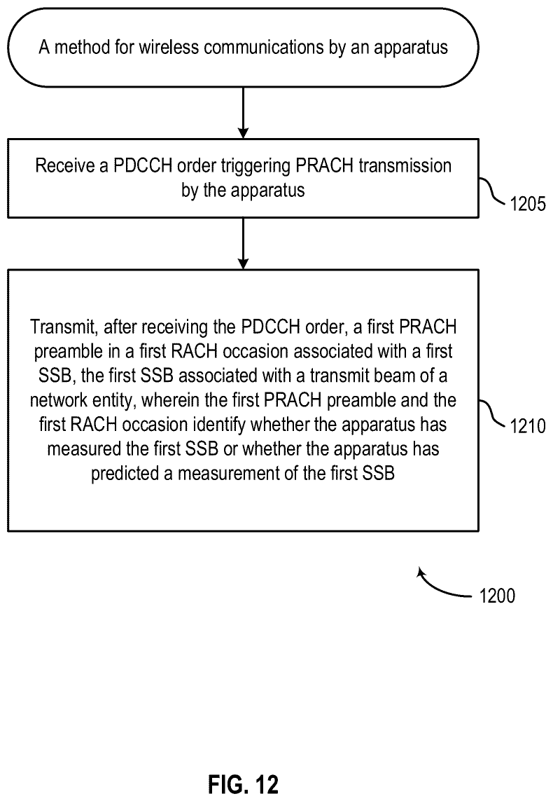

FIG. 12 shows a method 1200 for wireless communications by an apparatus, such as UE 104 of FIGS. 1 and 3.

Method 1200 begins at step 1205 with receiving a PDCCH order triggering PRACH transmission by the apparatus.

Method 1200 then proceeds to step 1210 with transmitting, after receiving the PDCCH order, a first PRACH preamble in a first RACH occasion associated with a first SSB, the first SSB associated with a transmit beam of a network entity, wherein the first PRACH preamble and the first RACH occasion identify whether the apparatus has measured the first SSB or whether the apparatus has predicted a measurement of the first SSB.

In certain aspects, step 1205 includes receiving the PDCCH order from a second network entity.

In certain aspects, step 1205 includes receiving the PDCCH order from the network entity.

In certain aspects, step 1210 includes transmitting the first PRACH preamble to the network entity.

In certain aspects, the first PRACH preamble and the first RACH occasion identify at least one of a requested number of times to transmit a RAR PDSCH in response to the first PRACH preamble or a requested MCS.

In certain aspects, method 1200 further includes receiving one or more transmissions of the RAR PDSCH.

In certain aspects, each of the one or more transmissions of the RAR PDSCH is at least Type D quasi co-located with the first SSB.

In certain aspects, a number of the one or more transmissions of the RAR PDSCH is equal to the requested number of times to transmit RAR PDSCH.

In certain aspects, method 1200 further includes receiving a RAR PDCCH scheduling the one or more transmissions of the RAR PDSCH, the RAR PDCCH indicating a transmission time of only a first transmission in time of the RAR PDSCH.

In certain aspects, a number of the one or more transmissions of the RAR PDSCH is different than the requested number of times to transmit RAR PDSCH.

In certain aspects, method 1200 further includes receiving a RAR PDCCH scheduling the one or more transmissions of the RAR PDSCH, the RAR PDCCH indicating a transmission time of each of the one or more transmissions of the RAR PDSCH.

In certain aspects, the PDCCH order indicates a plurality of RACH occasions and a plurality of PRACH preambles, each combination of a RACH occasion of the plurality of RACH occasions and a PRACH preamble of the plurality of PRACH preambles identifying at least one of a different requested number of times to transmit the RAR PDSCH or a different requested MCS, wherein the plurality of RACH occasions are all associated with the first SSB.

In certain aspects, the PDCCH order indicates a second plurality of RACH occasions associated with a second SSB, the second SSB associated with a second transmit beam of the network entity.

In certain aspects, each combination of a PRACH preamble of a plurality of RACH preambles and a RACH occasion of a plurality of RACH occasions is a RACH resource, the RACH resources are ordered first according to RACH occasion index and second according to PRACH preamble identifier, and the ordered RACH resources are associated in order with at least one of different requested numbers of times to transmit the RAR PDSCH or different requested modulation and coding schemes.

In certain aspects, each combination of a PRACH preamble of a plurality of RACH preambles and a RACH occasion of a plurality of RACH occasions is a RACH resource, the RACH resources are ordered first according to PRACH preamble identifier and second according to RACH occasion index, and the ordered RACH resources are associated in order with at least one of different requested numbers of times to transmit the RAR PDSCH or different requested modulation and coding schemes.

In certain aspects, method 1200 further includes receiving an indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

In certain aspects, method 1200 further includes transmitting a first indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

In certain aspects, method 1200 further includes receiving a second indication identifying the one of the plurality of configurations or a different one of the plurality of configurations.

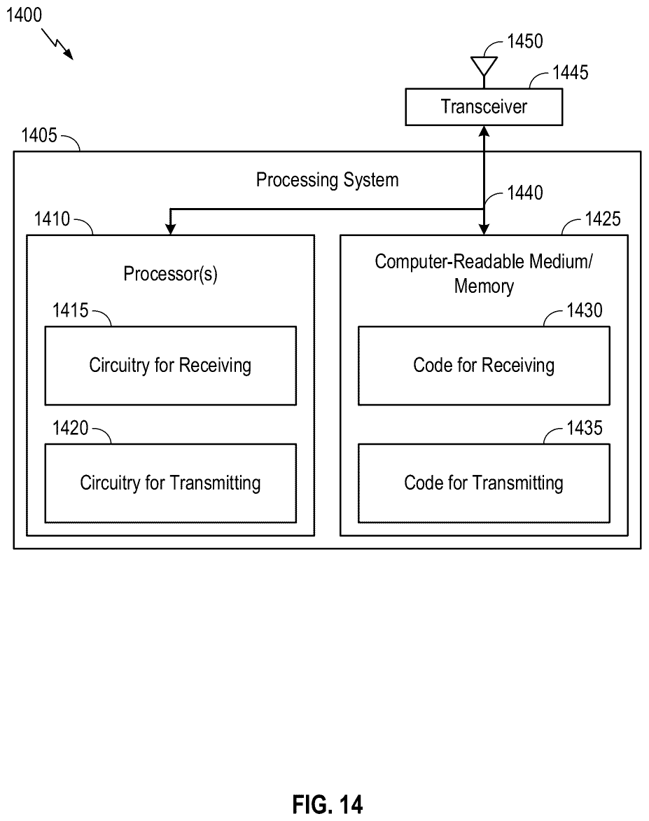

In certain aspects, method 1200, or any aspect related to it, may be performed by an apparatus, such as communications device 1400 of FIG. 14, which includes various components operable, configured, or adapted to perform the method 1200.

Communications device 1400 is described below in further detail.

Note that FIG. 12 is just one example of a method, and other methods including fewer, additional, or alternative steps are possible consistent with this disclosure.

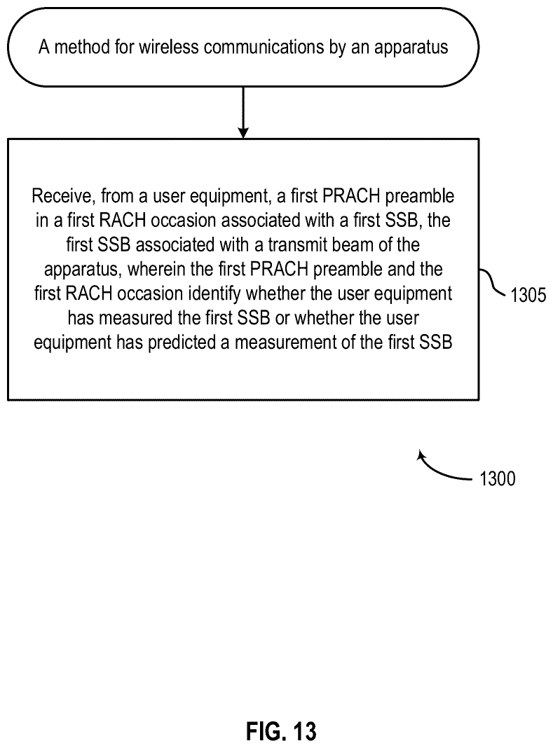

FIG. 13 shows a method 1300 for wireless communications by an apparatus, such as BS 102 of FIGS. 1 and 3, or a disaggregated base station as discussed with respect to FIG. 2.

Method 1300 begins at step 1305 with receiving, from a user equipment, a first PRACH preamble in a first RACH occasion associated with a first SSB, the first SSB associated with a transmit beam of the apparatus, wherein the first PRACH preamble and the first RACH occasion identify whether the user equipment has measured the first SSB or whether the user equipment has predicted a measurement of the first SSB.

In certain aspects, method 1300 further includes transmitting a PDCCH order triggering PRACH transmission.

In certain aspects, the first PRACH preamble and the first RACH occasion identify at least one of a requested number of times to transmit a RAR PDSCH in response to the first PRACH preamble or a requested MCS.

In certain aspects, method 1300 further includes transmitting one or more transmissions of the RAR PDSCH.

In certain aspects, each of the one or more transmissions of the RAR PDSCH is at least Type D quasi co-located with the first SSB.

In certain aspects, a number of the one or more transmissions of the RAR PDSCH is equal to the requested number of times to transmit RAR PDSCH.

In certain aspects, method 1300 further includes transmitting a RAR PDCCH scheduling the one or more transmissions of the RAR PDSCH, the RAR PDCCH indicating a transmission time of only a first transmission in time of the RAR PDSCH.

In certain aspects, a number of the one or more transmissions of the RAR PDSCH is different than the requested number of times to transmit RAR PDSCH.

In certain aspects, method 1300 further includes transmitting a RAR PDCCH scheduling the one or more transmissions of the RAR PDSCH, the RAR PDCCH indicating a transmission time of each of the one or more transmissions of the RAR PDSCH.

In certain aspects, the first PRACH preamble and the first RACH occasion identify at least one of a requested number of times to transmit a RAR PDSCH in response to the first PRACH preamble or a requested MCS, and the PDCCH order indicates a plurality of RACH occasions and a plurality of PRACH preambles, each combination of a RACH occasion of the plurality of RACH occasions and a PRACH preamble of the plurality of PRACH preambles identifying at least one of a different requested number of times to transmit the RAR PDSCH or a different requested MCS, wherein the plurality of RACH occasions are all associated with the first SSB.

In certain aspects, the PDCCH order indicates a second plurality of RACH occasions associated with a second SSB, the second SSB associated with a second transmit beam of the network entity.

In certain aspects, each combination of a PRACH preamble of a plurality of RACH preambles and a RACH occasion of a plurality of RACH occasions is a RACH resource, the RACH resources are ordered first according to RACH occasion index and second according to PRACH preamble identifier, and the ordered RACH resources are associated in order with at least one of different requested numbers of times to transmit the RAR PDSCH or different requested modulation and coding schemes.

In certain aspects, each combination of a PRACH preamble of a plurality of RACH preambles and a RACH occasion of a plurality of RACH occasions is a RACH resource, the RACH resources are ordered first according to PRACH preamble identifier and second according to RACH occasion index, and the ordered RACH resources are associated in order with at least one of different requested numbers of times to transmit the RAR PDSCH or different requested modulation and coding schemes.

In certain aspects, method 1300 further includes transmitting an indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

In certain aspects, method 1300 further includes receiving a first indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

In certain aspects, method 1300 further includes transmitting a second indication identifying the one of the plurality of configurations or a different one of the plurality of configurations.

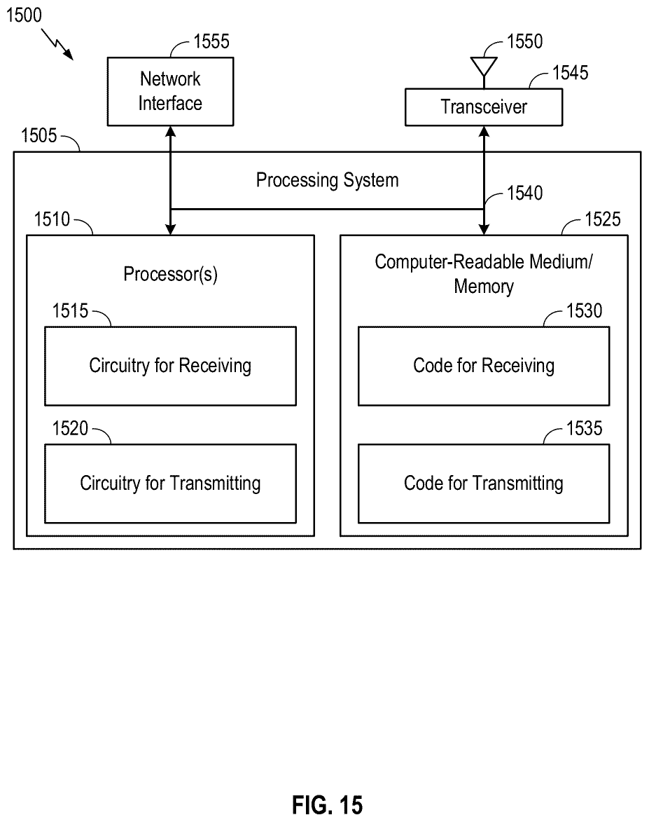

In certain aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, enable and cause the one or more processors 1410 to perform the method 1200 described with respect to FIG. 12, or any aspect related to it, including any additional steps or sub-steps described in relation to FIG. 12. Note that reference to a processor performing a function of communications device 1400 may include one or more processors performing that function of communications device 1400, such as in a distributed fashion.

In the depicted example, computer-readable medium/memory 1425 stores code for receiving 1430 and code for transmitting 1435. Processing of the code 1430 and 1435 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry for receiving 1415 and circuitry for transmitting 1420. Processing with circuitry 1415 and 1420 may enable and cause the communications device 1400 to perform the method 1200 described with respect to FIG. 12, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1445 and/or antenna 1450 of the communications device 1400 in FIG. 14, and/or one or more processors 1410 of the communications device 1400 in FIG. 14. Means for communicating, receiving or obtaining may include the transceivers 354, antenna(s) 352, receive processor 358, and/or controller/processor 380 of the UE 104 illustrated in FIG. 3, transceiver 1445 and/or antenna 1450 of the communications device 1400 in FIG. 14, and/or one or more processors 1410 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to a transceiver 1545 (e.g., a transmitter and/or a receiver) and/or a network interface 1555. The transceiver 1545 is configured to transmit and receive signals for the communications device 1500 via an antenna 1550, such as the various signals as described herein. The network interface 1555 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1525 via a bus 1540. In certain aspects, the computer-readable medium/memory 1525 is configured to store instructions (e.g., computer-executable code) that when executed by the one or more processors 1510, enable and cause the one or more processors 1510 to perform the method 1300 described with respect to FIG. 13, or any aspect related to it, including any additional steps or sub-steps described in relation to FIG. 13. Note that reference to a processor of communications device 1500 performing a function may include one or more processors of communications device 1500 performing that function, such as in a distributed fashion.

In the depicted example, the computer-readable medium/memory 1525 stores code for receiving 1530 and code for transmitting 1535. Processing of the code 1530 and 1535 may enable and cause the communications device 1500 to perform the method 1300 described with respect to FIG. 13, or any aspect related to it.

The one or more processors 1510 include circuitry configured to implement (e.g., execute) the code stored in the computer-readable medium/memory 1525, including circuitry for receiving 1515 and circuitry for transmitting 1520. Processing with circuitry 1515 and 1520 may enable and cause the communications device 1500 to perform the method 1300 described with respect to FIG. 13, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1545 and/or antenna 1550 of the communications device 1500 in FIG. 15, and/or one or more processors 1510 of the communications device 1500 in FIG. 15. Means for communicating, receiving or obtaining may include the transceivers 332, antenna(s) 334, receive processor 338, and/or controller/processor 340 of the BS 102 illustrated in FIG. 3, transceiver 1545 and/or antenna 1550 of the communications device 1500 in FIG. 15, and/or one or more processors 1510 of the communications device 1500 in FIG. 15.

### Example Clauses

Implementation examples are described in the following numbered clauses:

Clause 1: A method for wireless communications by an apparatus, comprising: receiving a PDCCH order triggering PRACH transmission by the apparatus; and after receiving the PDCCH order, transmitting a first PRACH preamble in a first RACH occasion associated with a first SSB, the first SSB associated with a transmit beam of a network entity, wherein the first PRACH preamble and the first RACH occasion identify whether the apparatus has measured the first SSB or whether the apparatus has predicted a measurement of the first SSB.

Clause 2: The method of Clause 1, wherein receiving the PDCCH order comprises: receiving the PDCCH order from a second network entity.

Clause 3: The method of Clause 1, wherein receiving the PDCCH order comprises: receiving the PDCCH order from the network entity.

Clause 4: The method of any one of Clauses 1-3, wherein transmitting the first PRACH preamble comprises: transmitting the first PRACH preamble to the network entity.

Clause 5: The method of any one of Clauses 1-4, wherein the first PRACH preamble and the first RACH occasion identify at least one of a requested number of times to transmit a RAR PDSCH in response to the first PRACH preamble or a requested MCS.

Clause 6: The method of Clause 5, further comprising: receiving one or more transmissions of the RAR PDSCH.

Clause 7: The method of Clause 6, wherein each of the one or more transmissions of the RAR PDSCH is at least Type D quasi co-located with the first SSB.

Clause 8: The method of Clause 6, wherein a number of the one or more transmissions of the RAR PDSCH is equal to the requested number of times to transmit RAR PDSCH.

Clause 9: The method of Clause 8, further comprising: receiving a RAR PDCCH scheduling the one or more transmissions of the RAR PDSCH, the RAR PDCCH indicating a transmission time of only a first transmission in time of the RAR PDSCH.

Clause 10: The method of Clause 6, wherein a number of the one or more transmissions of the RAR PDSCH is different than the requested number of times to transmit RAR PDSCH.

Clause 11: The method of Clause 10, further comprising: receiving a RAR PDCCH scheduling the one or more transmissions of the RAR PDSCH, the RAR PDCCH indicating a transmission time of each of the one or more transmissions of the RAR PDSCH.

Clause 12: The method of Clause 5, wherein the PDCCH order indicates a plurality of RACH occasions and a plurality of PRACH preambles, each combination of a RACH occasion of the plurality of RACH occasions and a PRACH preamble of the plurality of PRACH preambles identifying at least one of a different requested number of times to transmit the RAR PDSCH or a different requested MCS, wherein the plurality of RACH occasions are all associated with the first SSB.

Clause 13: The method of Clause 12, wherein the PDCCH order indicates a second plurality of RACH occasions associated with a second SSB, the second SSB associated with a second transmit beam of the network entity.

Clause 14: The method of Clause 5, wherein: each combination of a PRACH preamble of a plurality of RACH preambles and a RACH occasion of a plurality of RACH occasions is a RACH resource, the RACH resources are ordered first according to RACH occasion index and second according to PRACH preamble identifier, and the ordered RACH resources are associated in order with at least one of different requested numbers of times to transmit the RAR PDSCH or different requested modulation and coding schemes.

Clause 15: The method of Clause 5, wherein: each combination of a PRACH preamble of a plurality of RACH preambles and a RACH occasion of a plurality of RACH occasions is a RACH resource, the RACH resources are ordered first according to PRACH preamble identifier and second according to RACH occasion index, and the ordered RACH resources are associated in order with at least one of different requested numbers of times to transmit the RAR PDSCH or different requested modulation and coding schemes.

Clause 16: The method of Clause 5, further comprising: receiving an indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

Clause 17: The method of Clause 5, further comprising: transmitting a first indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

Clause 18: The method of Clause 17, further comprising: receiving a second indication identifying the one of the plurality of configurations or a different one of the plurality of configurations.

Clause 19: A method for wireless communications by an apparatus, comprising: receiving, from a user equipment, a first PRACH preamble in a first RACH occasion associated with a first SSB, the first SSB associated with a transmit beam of the apparatus, wherein the first PRACH preamble and the first RACH occasion identify whether the user equipment has measured the first SSB or whether the user equipment has predicted a measurement of the first SSB. In certain aspects, the method includes communicating with the user equipment using the transmit beam.

Clause 20: The method of Clause 19, further comprising: transmitting a PDCCH order triggering PRACH transmission.

Clause 21: The method of any one of Clauses 19-20, wherein receiving the first PRACH preamble comprises: receiving the first PRACH preamble from the user equipment.

Clause 22: The method of any one of Clauses 19-21, wherein the first PRACH preamble and the first RACH occasion identify at least one of a requested number of times to transmit a RAR PDSCH in response to the first PRACH preamble or a requested MCS.

Clause 23: The method of Clause 22, further comprising: transmitting one or more transmissions of the RAR PDSCH.

Clause 24: The method of Clause 23, wherein each of the one or more transmissions of the RAR PDSCH is at least Type D quasi co-located with the first SSB.

Clause 25: The method of Clause 23, wherein a number of the one or more transmissions of the RAR PDSCH is equal to the requested number of times to transmit RAR PDSCH.

Clause 26: The method of Clause 25, further comprising: transmitting a RAR PDCCH scheduling the one or more transmissions of the RAR PDSCH, the RAR PDCCH indicating a transmission time of only a first transmission in time of the RAR PDSCH.

Clause 27: The method of Clause 23, wherein a number of the one or more transmissions of the RAR PDSCH is different than the requested number of times to transmit RAR PDSCH.

Clause 28: The method of Clause 27, further comprising: transmitting a RAR PDCCH scheduling the one or more transmissions of the RAR PDSCH, the RAR PDCCH indicating a transmission time of each of the one or more transmissions of the RAR PDSCH.

Clause 29: The method of Clause 20, wherein: the first PRACH preamble and the first RACH occasion identify at least one of a requested number of times to transmit a RAR PDSCH in response to the first PRACH preamble or a requested MCS, and the PDCCH order indicates a plurality of RACH occasions and a plurality of PRACH preambles, each combination of a RACH occasion of the plurality of RACH occasions and a PRACH preamble of the plurality of PRACH preambles identifying at least one of a different requested number of times to transmit the RAR PDSCH or a different requested MCS, wherein the plurality of RACH occasions are all associated with the first SSB.

Clause 30: The method of Clause 29, wherein the PDCCH order indicates a second plurality of RACH occasions associated with a second SSB, the second SSB associated with a second transmit beam of the network entity.

Clause 31: The method of Clause 22, wherein: each combination of a PRACH preamble of a plurality of RACH preambles and a RACH occasion of a plurality of RACH occasions is a RACH resource, the RACH resources are ordered first according to RACH occasion index and second according to PRACH preamble identifier, and the ordered RACH resources are associated in order with at least one of different requested numbers of times to transmit the RAR PDSCH or different requested modulation and coding schemes.

Clause 32: The method of Clause 22, wherein: each combination of a PRACH preamble of a plurality of RACH preambles and a RACH occasion of a plurality of RACH occasions is a RACH resource, the RACH resources are ordered first according to PRACH preamble identifier and second according to RACH occasion index, and the ordered RACH resources are associated in order with at least one of different requested numbers of times to transmit the RAR PDSCH or different requested modulation and coding schemes.

Clause 33: The method of Clause 22, further comprising: transmitting an indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

Clause 34: The method of Clause 22, further comprising: receiving a first indication identifying one of a plurality of configurations comprising a first configuration and a second configuration, wherein: the first configuration maps combinations of a plurality of RACH occasions and a plurality of PRACH preambles to at least one of a first set of requested numbers of times to transmit the RAR PDSCH or a first set of requested modulation and coding schemes, and the second configuration maps the combinations of the plurality of RACH occasions and the plurality of PRACH preambles to at least one of a second set of requested numbers of times to transmit the RAR PDSCH or a second set of requested modulation and coding schemes.

Clause 35: The method of Clause 34, further comprising: transmitting a second indication identifying the one of the plurality of configurations or a different one of the plurality of configurations.

Clause 36: One or more apparatuses, comprising: one or more memories comprising executable instructions; and one or more processors configured to execute the executable instructions and cause the one or more apparatuses to perform a method in accordance with any one of clauses 1-35.

Clause 37: One or more apparatuses, comprising means for performing a method in accordance with any one of clauses 1-35.

Clause 38: One or more non-transitory computer-readable media comprising executable instructions that, when executed by one or more processors of one or more apparatuses, cause the one or more apparatuses to perform a method in accordance with any one of clauses 1-35.

Clause 39: One or more computer program products embodied on one or more computer-readable storage media comprising code for performing a method in accordance with any one of clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus configured for wireless communications, comprising:
one or more memories comprising processor-executable instructions; and
one or more processors configured to execute the processor-executable instructions and cause the apparatus to:
receive a physical downlink control channel (PDCCH) order triggering physical random access channel (PRACH) transmission by the apparatus; and
after receiving the PDCCH order, transmit a first PRACH preamble in a first random access channel (RACH) occasion associated with a first synchronization signal block (SSB), the first SSB associated with a transmit beam of a network entity, wherein the first PRACH preamble and the first RACH occasion identify whether the apparatus has measured the first SSB or whether the apparatus has predicted a measurement of the first SSB.

2. The apparatus of claim 1, wherein, to receive the PDCCH order, the one or more processors are configured to execute the processor-executable instructions and cause the apparatus to:
receive the PDCCH order from a second network entity.

3. The apparatus of claim 1, wherein, to receive the PDCCH order, the one or more processors are configured to execute the processor-executable instructions and cause the apparatus to:
receive the PDCCH order from the network entity.

4. The apparatus of claim 1, wherein, to transmit the first PRACH preamble, the one or more processors are configured to execute the processor-executable instructions and cause the apparatus to:
transmit the first PRACH preamble to the network entity.

5. The apparatus of claim 1, wherein the first PRACH preamble and the first RACH occasion identify at least one of a requested number of times to transmit a random access response (RAR) physical downlink shared channel (PDSCH) in response to the first PRACH preamble or a requested modulation and coding scheme (MCS).

6. The apparatus of claim 5, wherein the one or more processors are configured to execute the processor-executable instructions and cause the apparatus to:
receive one or more transmissions of the RAR PDSCH.

7. The apparatus of claim 6, wherein each of the one or more transmissions of the RAR PDSCH is at least Type D quasi co-located with the first SSB.

8. The apparatus of claim 6, wherein a number of the one or more transmissions of the RAR PDSCH is equal to the requested number of times to transmit RAR PDSCH.

9. The apparatus of claim 8, wherein the one or more processors are configured to execute the processor-executable instructions and cause the apparatus to:
receive a RAR PDCCH scheduling the one or more transmissions of the RAR PDSCH, the RAR PDCCH indicating a transmission time of only a first transmission in time of the RAR PDSCH.

10. The apparatus of claim 6, wherein a number of the one or more transmissions of the RAR PDSCH is different than the requested number of times to transmit RAR PDSCH.

11. The apparatus of claim 10, wherein the one or more processors are configured to execute the processor-executable instructions and cause the apparatus to:
receive a RAR PDCCH scheduling the one or more transmissions of the RAR PDSCH, the RAR PDCCH indicating a transmission time of each of the one or more transmissions of the RAR PDSCH.

12. The apparatus of claim 5, wherein the PDCCH order indicates a plurality of RACH occasions and a plurality of PRACH preambles, each combination of a RACH occasion of the plurality of RACH occasions and a PRACH preamble of the plurality of PRACH preambles identifying at least one of a different requested number of times to transmit the RAR PDSCH or a different requested MCS, wherein the plurality of RACH occasions are all associated with the first SSB.

13. The apparatus of claim 12, wherein the PDCCH order indicates a second plurality of RACH occasions associated with a second SSB, the second SSB associated with a second transmit beam of the network entity.

14. The apparatus of claim 5, wherein:
each combination of a PRACH preamble of a plurality of RACH preambles and a RACH occasion of a plurality of RACH occasions is a RACH resource,
the RACH resources are ordered first according to RACH occasion index and second according to PRACH preamble identifier, and
the ordered RACH resources are associated in order with at least one of different requested numbers of times to transmit the RAR PDSCH or different requested modulation and coding schemes.

15. The apparatus of claim 5, wherein:
each combination of a PRACH preamble of a plurality of RACH preambles and a RACH occasion of a plurality of RACH occasions is a RACH resource,
the RACH resources are ordered first according to PRACH preamble identifier and second according to RACH occasion index, and
the ordered RACH resources are associated in order with at least one of different requested numbers of times to transmit the RAR PDSCH or different requested modulation and coding schemes.

16. The apparatus of claim 5, wherein the one or more processors are configured to execute the processor-executable instructions and cause the apparatus to:
receive an indication identifying one of a plurality of configurations comprising a first configuration and a second configuration, wherein:
the first configuration maps combinations of a plurality of RACH occasions and a plurality of PRACH preambles to at least one of a first set of requested numbers of times to transmit the RAR PDSCH or a first set of requested modulation and coding schemes, and
the second configuration maps the combinations of the plurality of RACH occasions and the plurality of PRACH preambles to at least one of a second set of requested numbers of times to transmit the RAR PDSCH or a second set of requested modulation and coding schemes.

17. The apparatus of claim 5, wherein the one or more processors are configured to execute the processor-executable instructions and cause the apparatus to:
transmit a first indication identifying one of a plurality of configurations comprising a first configuration and a second configuration, wherein:
the first configuration maps combinations of a plurality of RACH occasions and a plurality of PRACH preambles to at least one of a first set of requested numbers of times to transmit the RAR PDSCH or a first set of requested modulation and coding schemes, and
the second configuration maps the combinations of the plurality of RACH occasions and the plurality of PRACH preambles to at least one of a second set of requested numbers of times to transmit the RAR PDSCH or a second set of requested modulation and coding schemes.

18. The apparatus of claim 17, wherein the one or more processors are configured to execute the processor-executable instructions and cause the apparatus to:
receive a second indication identifying the one of the plurality of configurations or a different one of the plurality of configurations.

19. An apparatus configured for wireless communications, comprising:
one or more memories comprising processor-executable instructions; and
one or more processors configured to execute the processor-executable instructions and cause the apparatus to:
receive, from a user equipment (UE), a first physical random access channel (PRACH) preamble in a first random access channel (RACH) occasion associated with a first synchronization signal block (SSB), the first SSB associated with a transmit beam of the apparatus, wherein the first PRACH preamble and the first RACH occasion identify whether the UE has measured the first SSB or whether the UE has predicted a measurement of the first SSB; and
communicate with the user equipment using the transmit beam.

20-25. (canceled)

26. A method for wireless communications by an apparatus, comprising:
receiving, from a user equipment (UE), a first physical random access channel (PRACH) preamble in a first random access channel (RACH) occasion associated with a first synchronization signal block (SSB), the first SSB associated with a transmit beam of the apparatus, wherein the first PRACH preamble and the first RACH occasion identify whether the UE has measured the first SSB or whether the UE has predicted a measurement of the first SSB; and
communicating with the user equipment using the transmit beam.

27-30. (canceled)
